(19) United States
(12) Patent Application Publication
(10) Pub. No.: US 2023/0003683 A1
(43) Pub. Date: Jan. 5, 2023

(54) Digital microfluidics (DMF) device including an FET-biosensor (FETB) and method of field-effect sensing

(71) Applicant: Nicoya LifeSciences, Inc., Kitchener (CA)

(72) Inventors: Ryan Denomme, Kitchener (CA); Gordon Hall, Milton (CA)

(21) Appl. No.: 17/778,604

(22) PCT Filed: Nov. 23, 2020
(86) PCT No.: PCT/CA2020/051592

§ 371 Date: May 20, 2022

Related U.S. Application Data
(60) Provisional application No. 62/939,017, filed on Nov. 22, 2019.

(51) Int. Cl. G01N 27/414; B01L 3/00

(52) U.S. Cl. CPC G01N 27/4145; B01L 3/502784; G01N 27/4148; B01L 2300/0636; B01L 2300/0645; B01L 2400/0427; B01L 2300/161; B01L 2200/04; B01L 2200/16

(57) ABSTRACT

A digital microfluidics (DMF) device including an FET-biosensor (FETB) and method of field-effect sensing is closed. In some embodiments, the DMF device may include one or more FETBs integrated into the top substrate, the bottom substrate, or both the top and bottom substrates of the DMF device. In some embodiments, the DMF device may include one or more “drop-in” style FETBs in the top substrate, the bottom substrate, or both the top and bottom substrates of the DMF device. In some embodiments, the DMF device, FETB, and method of field-effect sensing provide active-matrix control integrated into an active-matrix DMF device. Further, a microfluidics system for and method of using the DMF device including at least one FETB is provided.

### TECHNICAL FIELD

The presently disclosed subject matter relates generally to the detection of molecules, such as DNA, proteins, drugs, and the like, and more particularly to a digital microfluidics (DMF) device including a field effect transistor biosensor (FETB) and method of field-effect sensing.

### BACKGROUND

A DMF device differs from a continuous flow microfluidic device in that operations are executed on discrete fluidic droplets as compared to continuous flow through channels. Typically, this is done using electrowetting-on-dielectric (EWOD) in which a surface can be modulated between being relatively hydrophobic and relatively hydrophilic based on the application of a voltage. EWOD devices make use of an electrode to which a voltage is applied. The electrowetting voltage used to induce the movement of droplets can be, for example, a DC voltage or an AC voltage. A dielectric layer separates the droplet and the electrode and contains an electrical field which effectively makes the dielectric surface more hydrophilic. In a typical implementation, the dielectric layer may have a hydrophobic coating that establishes an initially high contact angle between the droplet and dielectric surface. By toggling a grid of electrowetting electrodes, a surface energy gradient can be established which propels the fluidic droplet across the surface of the DMF device from one electrode to another. Additionally, in a DMF device, magnetic or optical forces can be used to localize and/or move fluidic droplets. Further, in a DMF device, an optical signal can be focused on a semiconductor to generate the electrowetting voltage.

A typical device architecture may include two substrates separated by a gap and wherein a multi-layer structure is built upon each substrate. For example, a bottom substrate may include a layer of discrete electrodes. Atop the electrode layer may be the dielectric layer to facilitate the buildup of charge for the EWOD effect. Atop the dielectric layer may be the hydrophobic layer to create an initially high contact angle and low contact angle hysteresis. The fluidic droplets are contained in the gap between the bottom and top substrates. In some configurations, a top substrate includes a conductive layer to provide a ground reference for the EWOD system. A second hydrophobic layer atop the conductive layer in the top substrate faces the gap. Thus, the device can be considered in two portions, with a gap therebetween: the bottom portion that may include the bottom substrate, the electrodes, the dielectric, and a hydrophobic layer and a top portion that may include another hydrophobic layer, the ground reference layer, and the top substrate.

The bottom portion of DMF devices can be fabricated on a variety of substrates including but not limited to silicon, glass, printed circuit boards (PCB), and paper. The choice of substrate may influence the technology used to pattern the electrodes, which, for example, includes photolithography for silicon, glass and PCBs, and printing for paper. The dielectric material can be applied in methods including but not limited to an evaporated layer, as a sputtered layer or as a laminated sheet. The hydrophobic layer can be deposited in methods including, but not limited to, spin coating, spray coating, and dip coating. The top portion typically consists of a conductive layer (often indium tin oxide) coated onto a plastic or glass substrate with a hydrophobic layer deposited as above.

There are a few primary challenges with DMF devices, notably in the implementation of a smooth and uniform hydrophobic layer on both the top and bottom portions; any disturbance in this film could result in pinned droplets that do not move as expected. Accordingly, new approaches are needed for implementing sensing techniques in DMF devices that do not perturb droplet movement.

### SUMMARY

The present disclosure provides an electrowetting digital microfluidics (DMF) device. The electrowetting device includes electrodes for conducting droplet operations, and an FETB. The FETB may be situated in sufficient proximity to a set of one or more of the electrodes that a droplet subject to droplet operations mediated by the set of one or more electrodes will come into contact with the FETB. The FETB has a first portion comprising an exposed hydrophilic surface area of a sufficiently small size that the set of one or more electrodes is capable of conducting droplet operations to remove the droplet, when present, from contact with the FETB. In this regard, the exposed hydrophilic surface area may be sized in relation to a droplet to allow for the droplet to be removed or substantially removed when the droplet is migrated from the FETB using the electrodes. That is, the droplet may fully separate or substantially fully separate from the FETB upon migration of the droplet away from the FETB by the electrodes.

In another embodiment, the electrowetting device of the present disclosure has two substrates separated to form a droplet operations gap. One or both of the substrates may include droplet operations electrodes. One or both of the substrates may include an FETB. An FETB may be mounted on one of the substrates in sufficient proximity to a subset of one or more of the droplet operations electrodes such the subset may mediate droplet operations causing the droplet to contact the FETB and to fully separate or substantially fully separate from the FETB.

The present disclosure also provides an instrument. The instrument in this embodiment includes FETB drive circuitry; FETB read circuitry; and circuitry for controlling droplet operations electrodes. The FETB may be provided with an electrowetting DMF cartridge that may interface with the instrument. Thus, the instrument may include includes a mount for physically and electronically coupling the instrument to the electrowetting DMF cartridge. The mount includes connectors for electronically coupling the FETB drive circuitry and FETB read circuitry of the instrument to an FETB of the electrowetting DMF cartridge. The mount includes connectors for electronically coupling the circuitry of the instrument for controlling droplet operations electrodes to one or more droplet operations electrodes of the electrowetting cartridge.

The present disclosure provides a detection method. The method includes using electrowetting electrodes to cause a sample droplet to contact an FETB. The method includes detecting an analyte in the sample droplet using the FETB. The method includes using electrowetting electrodes to separate all or substantially all of the sample droplet from the FETB.

These and other embodiments are more fully explained in the Detailed Description, including with reference to the Figures.

### BRIEF DESCRIPTION OF DRAWINGS

Having thus described the presently disclosed subject matter in general terms, reference will now be made to the accompanying drawings, which are not necessarily drawn to scale, and wherein:

FIG. 1 is a cross-sectional view illustrating an example of the DMF device including an FET-biosensor (FETB) integrated into the top substrate thereof for the analysis of analytes;

FIG. 2A and FIG. 2B are plan views illustrating an example of the patterning of the integrated FETB in the DMF device shown in FIG. 1;

FIG. 3 is a cross-sectional view illustrating an example of the DMF device including an FETB integrated into the bottom substrate thereof for the analysis of analytes;

FIG. 4A and FIG. 4B are plan views illustrating an example of integrating the ground reference and the FETB return electrode in-plane with the integrated FETB in the bottom substrate of the DMF device;

FIG. 5 is a cross-sectional view illustrating an example of the DMF device including an FETB integrated into both the top and bottom substrates thereof for the analysis of analytes;

FIG. 6A and FIG. 6B are cross-sectional views illustrating an example of a “drop-in” style FETB and another example of the DMF device wherein the top substrate is designed to receive the “drop-in” style FETB;

FIG. 7 is a cross-sectional view illustrating an example of the DMF device including an FETB integrated into the bottom substrate thereof and a “drop-in” style FETB installed in the top substrate thereof;

FIG. 8 is a cross-sectional view illustrating an example of the DMF device including active-matrix control in combination with an integrated FETB in the bottom substrate thereof;

FIG. 9 is a plan view of an example illustrating the patterning of the active-matrix controlled DMF device and FETB shown in FIG. 8;

FIG. 10 is a flow diagram illustrating an example of a method of using the DMF device that may include an FETB for the analysis of analytes; and

FIG. 11 is a block diagram illustrating an example of a microfluidics system that supports the DMF device that may include an FETB for the analysis of analytes.

### DETAILED DESCRIPTION

In some embodiments, the presently disclosed subject matter provides a digital microfluidics (DMF) device including an FET-biosensor (FETB) and method of field-effect sensing. Namely, the DMF device utilizes DMF (i.e., electrowetting) for fluid movement and a field-effect transistor (FET) as the sensor readout.

In some embodiments, the present disclosure provides (1) integrated nanowire or graphene-based devices for high sensitivity and streamlined manufacturing, (2) methods of integrating these devices with active-matrix technology for additional fluidic functionality, and/or (3) methods of integrating the sensor with previously-developed DMF technologies.

In some embodiments, the present disclosure provides methods of implementing FETB sensing in a manner wherein the FETB sensing that does not inhibit or disrupt droplet movement.

In some embodiments, the DMF device may include one or more integrated FETBs. In one example, the DMF device may include at least one FETB integrated into the top substrate of the DMF device. In another example, the DMF device may include at least one FETB integrated into the bottom substrate of the DMF device. In yet another example, the DMF device may include at least one FETB integrated into the top substrate as well as at least one FETB integrated into the bottom substrate of the DMF device.

In some embodiments, the FETB is provided separate from the DMF device and wherein the separately provided FETB can be installed into the DMF device, e.g., as a “drop-in” style FETB. Accordingly, the DMF device may include one or more “drop-in” style FETBs. In one example, at least one “drop-in” style FETB is installed in the top substrate of the DMF device. In another example, at least one “drop-in” style FETB is installed in the bottom substrate of the DMF device. In yet another example, at least one “drop-in” style FETB is installed in the top substrate as well as at least one “drop-in” style FETB is installed in the bottom substrate of the DMF device.

In some embodiments, the DMF device, FETB, and method of field-effect sensing provide active-matrix control integrated into an active-matrix DMF device.

Further, a microfluidics system for and method of using the DMF device including at least one FETB is provided.

Field Effect Transistor Biosensing

The basic principle of FETB is that a field effect transistor (FET) device is made such that the source and drain are isolated from a reagent while the gate is exposed to the reagent. In this arrangement, there exists an electric double layer in the aqueous phase along the gate which can be perturbed by various stimuli. For example, a change in pH of the reagent contacting the gate will change this layer resulting in a different gate potential. In a biosensing application, a ligand may be immobilized on the surface to capture a target analyte in the reagent. When this analyte binds to the ligand, the gate potential is perturbed. The change in gate voltage can be detected by observing a modulation of the source-drain current at a given voltage.

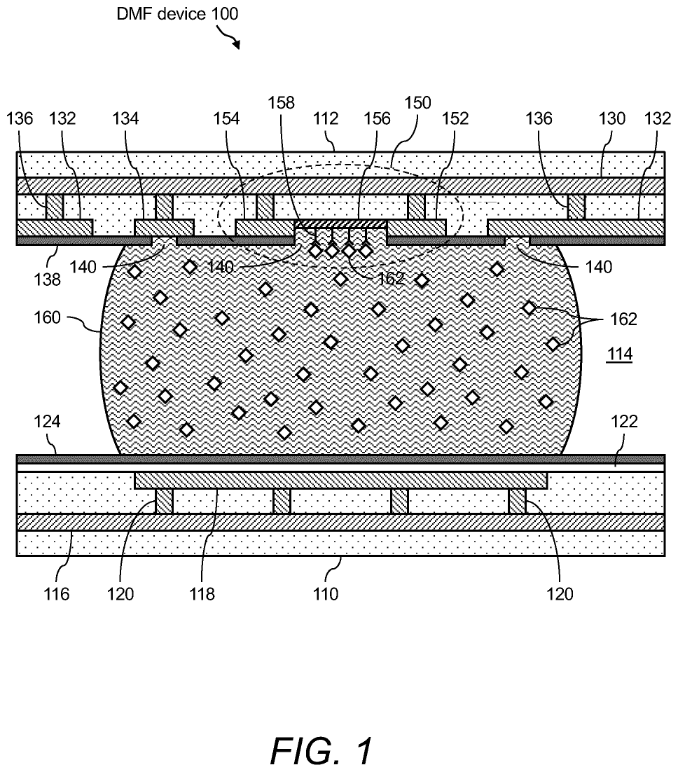

There are many methods of implementing a FETB based on the materials used. For example, the device can be structured using conventional silicon semiconductor or with a thin-film transistor (TFT). More recently, nanomaterials have been developed with many advantages, such as silicon nanowires or using graphene that have improved sensitivity. Specifically, graphene-based FETB devices currently exist. A practical implementation of FETB requires the patterning and fabrication of the transistor elements (typically photolithography on silicon) followed by the creation of the gate depending on the technology. While floating-gate architectures exist in which the liquid gate is the only interaction with the sample, these devices often have stability and noise issues. To avoid these issues, a reference electrode and an FETB return electrode need also be introduced to the system, as described hereinbelow with reference to FIG. 1 through FIG. 11. For example, the DMF device, FETB, and method of field-effect sensing provide three (3) points of contact: liquid gate and two electrodes. Further, one of the primary challenges of the field is integrating a sensor into a fluidic device for the analysis of analytes. As described hereinbelow, methods are provided of performing this integration in a manner that is generally applicable to any of the FETB materials.

FIG. 1 illustrates a cross-sectional view of an example of the DMF device 100 including an FET-biosensor (FETB) integrated into the top substrate thereof for the analysis of analytes.

DMF device 100 may include a bottom substrate 110 and a top substrate 112 separated by a droplet operations gap 114. In DMF device 100, the gap height can be from about 100 μm to about 500 μm in one example, or about 300 μm in another example.

Bottom substrate 110 may further include a routing layer 116 (i.e., a wiring routing layer) and one or more droplet operations electrodes 118 (i.e., electrowetting electrodes) that are electrically connected to routing layer 116 using vias 120. Vias 120 can be, for example, blind vias and/or plated through-hole vias. Additionally, a dielectric layer 122 is provided atop droplet operations electrodes 118. Next, a hydrophobic layer 124 is provided atop dielectric layer 122, wherein hydrophobic layer 124 is facing into droplet operations gap 114 and provides a droplet operations surface.

Top substrate 112 may further include a routing layer 130 (i.e., a wiring routing layer), a ground reference electrode 132, and an FETB return electrode 134. Ground reference electrode 132 and FETB return electrode 134 are electrically connected to routing layer 130 using vias 136. Vias 136 can be, for example, blind vias and/or plated through-hole vias.

Additionally, FETB 150 is integrated along top substrate 112 and in relation to at least one droplet operations electrode 118 of bottom substrate 110. In one example, a source electrode 152, a drain electrode 154, a gate layer 156, and FETB return electrode 134 form FETB 150. Further, a hydrophobic layer 138 is provided atop ground reference electrode 132, FETB return electrode 134, source electrode 152, and drain electrode 154, wherein hydrophobic layer 138 is facing into droplet operations gap 114 and provides a droplet operations surface.

Additionally, analyte capture elements 158 may be bound to gate layer 156 of FETB 150. Accordingly, gate layer 156 may comprise a functionalized gate layer 156. In one example, FETB 150 is a carboxyl-functionalized FETB device. Generally, the gate material of FETB 150 is a semiconductor or nanomaterial and wherein the gate voltage of FETB 150 is modulated by the liquid contents. For example, gate layer 156 may be a graphene gate that has carboxyl functional groups attached to it, which are analyte capture elements 158. FETB 150 can be used to measure the binding kinetics of a plurality of small-molecule targets to a ligand. For example, a droplet 160 is provided in droplet operations gap 114 and wherein droplet 160 may include certain target analytes 162 to be detected using FETB 150.

Additionally, an opening 140 in hydrophobic layer 138 may be provided at ground reference electrode 132 so that droplet 160 can be in direct contact with ground reference electrode 132. Similarly, another opening 140 in hydrophobic layer 138 is provided at FETB return electrode 134 so that droplet 160 can be in direct contact with FETB return electrode 134. Further, another opening 140 in hydrophobic layer 138 is provided at FETB 150 so that droplet 160 can be in direct contact with gate layer 156. In DMF device 100, droplet operations may occur in a bulk filler fluid (e.g., a low-viscosity oil, such as silicone oil or hexadecane filler fluid) or in air.

Referring still to DMF device 100 of FIG. 1, integrating a sensor, such as FETB 150, into DMF device 100 include at least three (3) considerations in the design. Firstly, the conductive ground layer in electrical contact with the droplet is preferably present so that it can complete the DMF circuit for fluid actuation. Generally, the conductive ground layer approximately overlays the actuation electrodes. Next, the hydrophobic layer may be patterned such that it does not block the access of the sensor to the fluid to be measured. Accordingly, one or more openings 140 in hydrophobic layer 138 may be provided at gate layer 156, ground reference electrode 132, and FETB return electrode 134 of FETB 150. Finally, the sum of the area of these openings in hydrophobic layer 138 is preferably small compared to the droplet area such that it does not present itself as a hydrophilic “pinning” location that hinders the mobility of the droplet. This last challenge is particularly salient to the integration of FETB, because FETB typically has three (3) points of contact that need to be made to the droplet and the sum of the areas of these hydrophilic access points preferably does not pin the droplet.

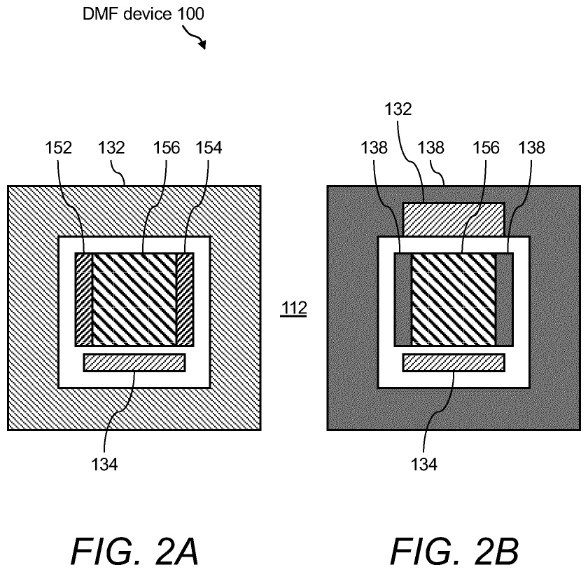

FIG. 2A and FIG. 2B illustrate plan views of an example of the patterning of the integrated FETB 150 in the DMF device 100 shown in FIG. 1. Namely, FIG. 2A shows the patterning of ground reference electrode 132 of top substrate 112 to allow source electrode 152, drain electrode 154, gate layer 156 and FETB return electrode 134 to be present to the solution (e.g., droplet 160). FIG. 2B shows the patterning of hydrophobic layer 138 in which only gate layer 156, FETB return electrode 134, and ground reference electrode 132 are exposed to the droplet.

Referring now again to FIG. 1, FIG. 2A, and FIG. 2B, the example of FETB 150 integrated into top substrate 112 of DMF device 100 is a configuration that is compatible with a wide variety of DMF fabrication technologies that focus primarily on the bottom substrate-portion. That is, in typical DMF designs, the top substrate-portion contains only the substrate, ground (optional), and hydrophobic layers, this design introduces a number of electrical functions. By contrast, the DMF device 100 may include FETB 150 integrated into its top substrate-portion and the top substrate-portion may include a number of electrical functions.

Both bottom substrate and top substrate 112 can be made from a variety of materials including silicon wafer materials. Routing layer 116 of bottom substrate 110 is representative of a plurality of routing layers for routing the required electrical signals. Likewise, routing layer 130 of top substrate 112 is representative of a plurality of routing layers for routing the required electrical signals. In top substrate 112 and close to droplet operations gap 114, ground reference electrode 132 is patterned to contain the FET source (e.g., source electrode 152) and drain (e.g., drain electrode 154) as well as FETB return electrode 134. Additionally, hydrophobic layer 138 of top substrate 112 is preferably patterned to enable fluidic access to FETB return electrode 134, ground reference electrode 132 (for reference access) and the gate area (e.g., gate layer 156). Hydrophobic layer 138 has the additional benefit of masking and isolating the source and drain regions.

Top substrate 112 of DMF device 100 may have a patterned hydrophobic layer 138 that allows the sensor (e.g., FETB 150) to be integrated with most DMF technologies. One design aspect of the DMF device 100 is that the hydrophobic layer sees minimal perturbation to reduce or prevent droplet pinning in which fluid from the droplet is trapped in contact with the exposed portion of the FETB and/or electrodes that may comprise a hydrophilic surface area. When any droplet operations electrode 118 of bottom substrate 110 is toggled on, the droplet stabilizes above the electrode. However, when this droplet operations electrode 118 is toggled off and an adjacent droplet operations electrode 118 is toggled on, the droplet should move to the new electrode to minimize its energy. The presence of hydrophilic surface areas associated with entities such as the electrodes in the integrated FETB 150 shown in FIG. 1 may perturb this system and could potentially cause droplets to be stuck on the FET features.

In this regard, the size exposed hydrophilic surface area may be controlled in relation to the droplet size to reduce or eliminate such pinning of the fluid of the droplet to allow the droplet to be removed or substantially removed by fully separating or substantially fully separating the fluid of the droplet from the hydrophilic surface area. By fully separated, substantially fully separating, removed, or substantially removed, it may mean that at least 75 volume percentage of the droplet may be removed from the hydrophilic surface area of the FETB, at least 80 volume percentage of the droplet may be removed from the hydrophilic surface area of the FETB, at least 90 volume percentage of the droplet may be removed from the hydrophilic surface area of the FETB, at least 95 volume percentage of the droplet may be removed from the hydrophilic surface area of the FETB, or even at least 99 volume percentage of the droplet may be removed from the hydrophilic surface area of the FETB.

In DMF device 100 the only exposed areas may be openings 140 that comprise a total surface area on the order of about 0.01 mm² to about 0.1 mm². Additionally or alternatively, the sum of the surface area of the openings 140 may be controlled in relation to a droplet footprint area of the droplet in the droplet operations gap. The droplet footprint area may correspond to an area contacted by the droplet at an interface with one or both of the substrates. In this regard, the openings 140 exposing the hydrophilic surface area of the FETB may comprise not more than 20% of a droplet footprint area of the droplet relative to the FETB, not more than 10% of a droplet footprint area of the droplet relative to the FETB, not more than 5% of a droplet footprint area of the droplet relative to the FETB, or even not more than 1% of a droplet footprint area of the droplet relative to the FETB.

Accordingly, exposed hydrophilic surface areas in the configuration of DMF device 100 that may cause pinning of the droplet may not present a sufficiently large area to pin a droplet as the thermodynamic stability of the system favors the entire droplet moving as opposed to it splitting or remaining stationary on the features of FETB 150 based on the relative area of the hydrophilic surface area relative to the droplet footprint area. Another consideration is that ground reference electrode 132 of top substrate 112 must be generally present wherever the droplet is to ensure that the circuit is completed properly and the DMF system can be reliably used. Accordingly, FIG. 2A and FIG. 2B show the patterning of both the ground and hydrophobic layers to minimize these issues.

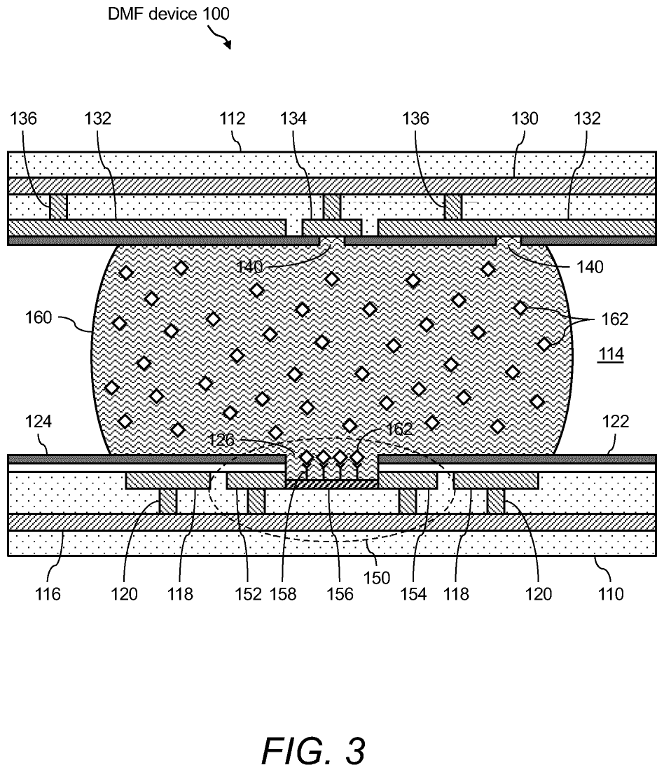

FIG. 3 illustrates a cross-sectional view of an example of the DMF device 100 including the FETB 150 integrated into the bottom substrate thereof for the analysis of analytes. In this example, the FETB 150 is integrated in bottom substrate 110 of DMF device 100 and in line with droplet operations electrodes 118. In one example, within the footprint of, for example, one droplet 160, FETB 150 is arranged between two droplet operations electrodes 118. In another example, within the footprint of, for example, one droplet 160, FETB 150 is arranged within a clearance region of a single droplet operations electrode 118. Additionally, an opening 126 in hydrophobic layer 124 is provided at FETB 150 so that droplet 160 can be in direct contact with gate layer 156.

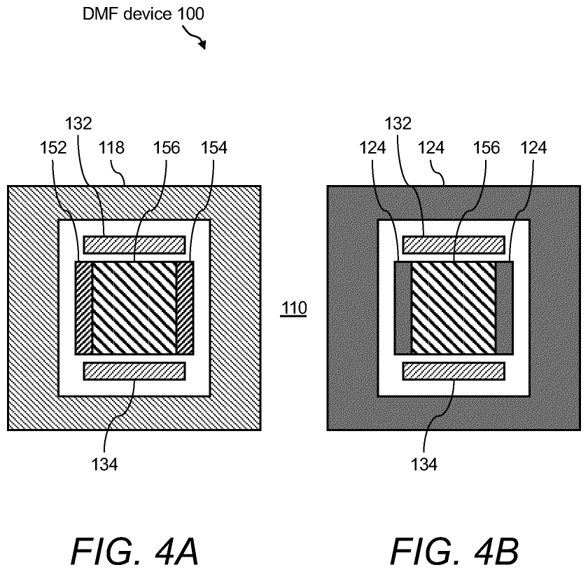

Further, in this example, the integrated FETB 150 in bottom substrate 110 is used in combination with features of top substrate 112; namely, with ground reference electrode 132 and its opening 140 along with FETB return electrode 134 and its opening 140. However, in another example, these features can instead be integrated into bottom substrate 110 of DMF device 100 as shown in FIG. 4A and FIG. 4B below.

FIG. 4A and FIG. 4B illustrate plan views of an example of integrating the ground reference and the FETB return electrode in-plane with the integrated FETB 150 in bottom substrate 110 of DMF device 100. This configuration enables the integration of FETB 150 into bottom substrate 110 of DMF device 100. FIG. 4A shows the patterning of the DMF-electrode layer while FIG. 4B shows the patterning of the hydrophobic and dielectric layer.

A benefit to integrating FETB 150 into bottom substrate 110 is that it may take advantage of synergies in the process of making a DMF device. Specifically, a standard DMF bottom substrate typically requires the patterning of metal plates and the routing of conductive lines that can be readily leveraged for making the source, drain, counter and pseudo-reference electrodes. Similar to the top substrate example of FIG. 1, the hydrophobic layer also naturally passivates the source and drain.

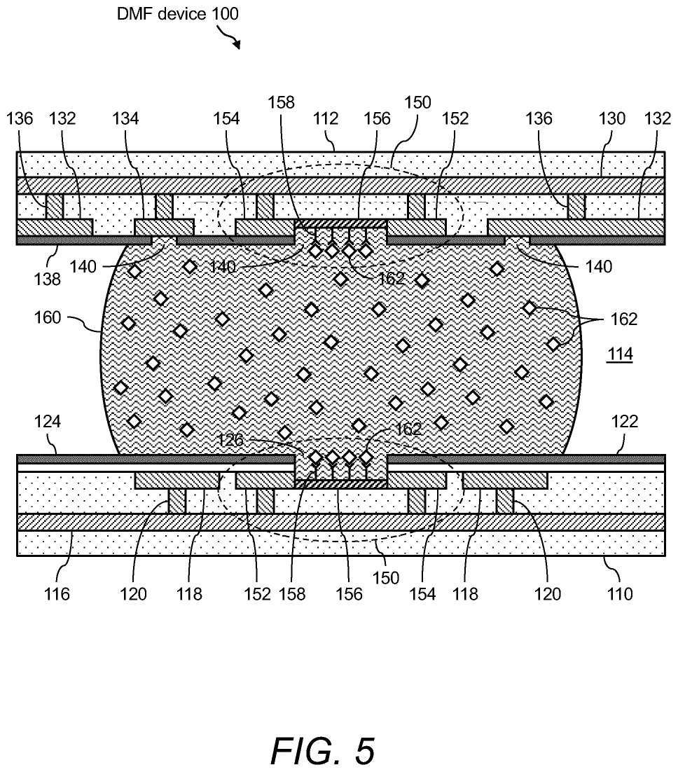

FIG. 5 illustrates a cross-sectional view of an example of the DMF device 100 including an FETB 150 integrated into both the top and bottom substrates thereof for the analysis of analytes. In this example, the top substrate configuration shown in FIG. 1 may be combined with the bottom substrate configuration shown in FIG. 3. This configuration that may include an FETB 150 integrated into both the top and bottom substrates can be useful to provide multiple sensors and/or provide multiple reference sensors. Namely, this configuration can be used to put either two sensors into the same droplet where each sensor has different surface chemistry or to stack sensors in alternating droplets to reduce routing complexity in each layer.

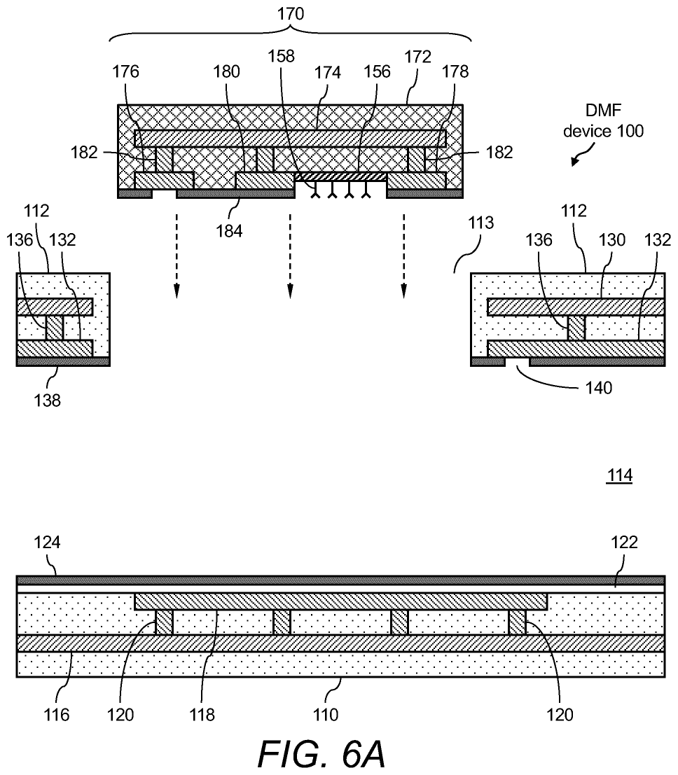

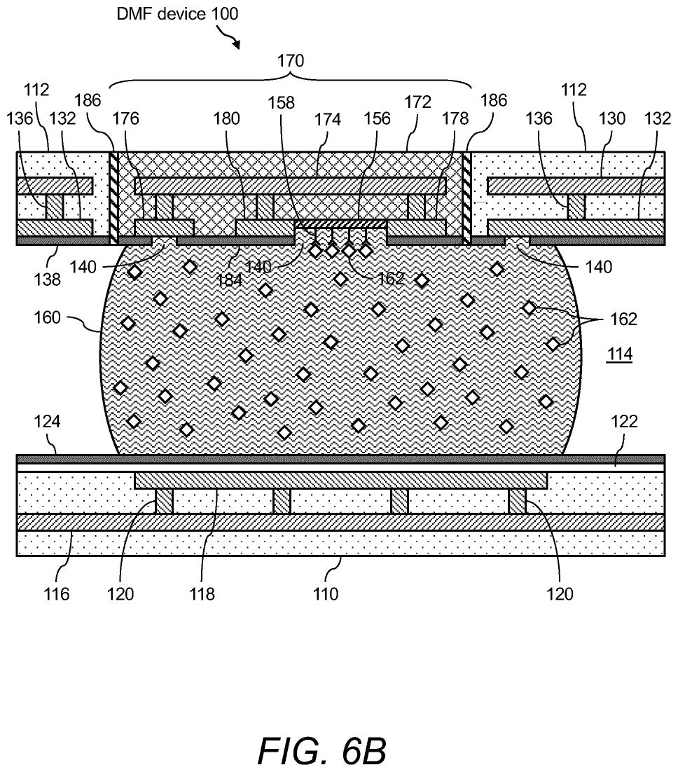

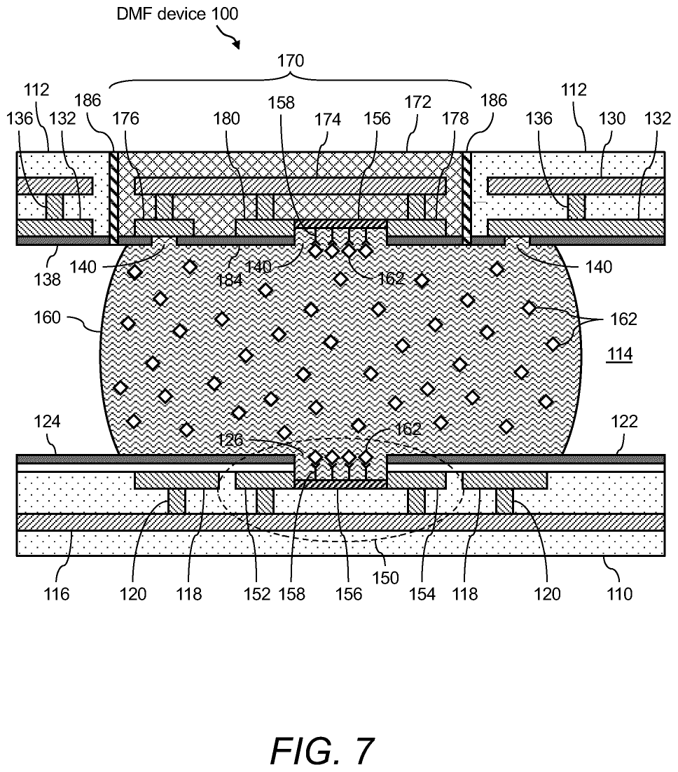

The presently disclosed DMF device 100 is not limited to the integrated FETBs 150 shown hereinabove with reference to FIG. 1 through FIG. 5. In another example, the DMF device 100 may include a “drop-in” style FETB that is formed separately from DMF device 100 and then installed therein. Examples of “drop-in” style FETBs are shown and described hereinbelow with reference to FIG. 6A, FIG. 6B, and FIG. 7.

FIG. 6A and FIG. 6B illustrate cross-sectional views of an example of a “drop-in” style FETB and another example of the DMF device 100 wherein top substrate 112 is designed to receive the “drop-in” style FETB. For example, a drop-in FETB 170 is provided in combination with a DMF device 100 that is designed to receive drop-in FETB 170. FIG. 6A shows drop-in FETB 170 prior to installing in top substrate 112 of DMF device 100. By contrast, FIG. 6B shows drop-in FETB 170 when installed in top substrate 112 of DMF device 100. DMF device 100 is not limited to receiving drop-in FETB 170 in top substrate 112 only. In another configuration (not shown), DMF device 100 may be designed to receive drop-in FETB 170 in bottom substrate 110. In yet another configuration (not shown), DMF device 100 may be designed to receive a drop-in FETB 170 in both the bottom substrate 110 and the top substrate 112.

In one example, drop-in FETB 170 may include a substrate 172 (e.g., a silicon substrate), a routing layer 174 (i.e., a wiring routing layer), an FETB return electrode 176, a source electrode 178, a drain electrode 180, and the gate layer 156 with its analyte capture elements 158 bound thereto. FETB return electrode 176, source electrode 178, and drain electrode 180 are electrically connected to routing layer 174 using vias 182. Further, a hydrophobic layer 184 is provided atop FETB return electrode 176, source electrode 178, and drain electrode 180, wherein hydrophobic layer 184 is facing into droplet operations gap 114 and provides a droplet operations surface.

Referring now to FIG. 6A, drop-in FETB 170 is designed to be fitted into an aperture 113 in top substrate 112 of DMF device 100. Referring now to FIG. 6B, drop-in FETB 170 may be fitted into aperture 113 of top substrate 112 and then held using an adhesive 186. Using a drop-in FETB 170, FIG. 6B shows another configuration of DMF device 100 that may include sensing in the top substrate only. However, in another example, FIG. 7 shows a cross-sectional view of an example of the DMF device 100 including an integrated FETB 150 in bottom substrate 110 and a drop-in FETB 170 installed in top substrate 112, which is another example of sensing provided in both the top and bottom substrates.

In comparison to the integrated FETB, the “drop-in” style FETB (e.g., drop-in FETB 170) may reduce the materials cost of DMF device 100, albeit with more fabrication steps. The primary benefit of using the “drop-in” style FETB is that it can be readily manufactured separate from the DMF-device development and then integrated at the end. This allows it to be used with a variety of DMF fabrication methods and integrated readily into existing technologies.

Further, the inclusion of the “drop-in” style FETB (e.g., drop-in FETB 170) may inhibit optical detection methods. This is because the “drop-in” style FETB is most likely opaque to light. Accordingly, in this example, infra-red camera may be used to image through, for example, drop-in FETB 170 and/or top substrate 112 of DMF device 100. Silicon, for example, is substantially transparent to infra-red.

Active Matrix Driving DMF

An active-matrix is a method of controlling an array of elements wherein the active element can be toggled by toggling the row and column that corresponds to the element. Therefore, a m×n matrix can be controlled with only m+n elements. This technology is primarily used in display technologies. However, in recent years the use of active-matrix control has been applied to DMF. Specifically, technologies have implemented thin-film transistor (TFT) devices that control DMF electrodes. The principle is that the desired DMF electrode is the drain of a transistor and can be accessed by applying the voltage to the source of the transistor and applying an activating voltage on the gate. In the case wherein only gate voltage is applied, the DMF electrode is connected to a floating source and therefore the droplet does not actuate. Furthermore, in the case where only the source has an applied voltage, this voltage does not convey to the drain without the gate voltage applied. One of the primary constraints with DMF is that a typical commercial device can have hundreds of electrodes that need to be controlled. With conventional control systems, the routing and switching on these devices can become prohibitively complicated. An active-matrix DMF device drastically increases the number of DMF electrodes that can be controlled by the device.

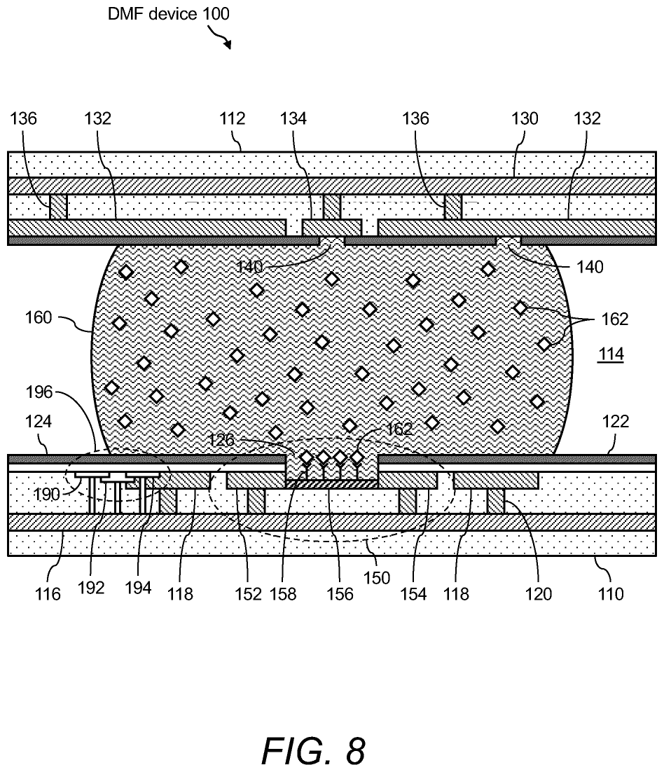

FIG. 8 illustrates a cross-sectional view of an example of the DMF device 100 including active-matrix control in combination with an integrated FETB 150 in the bottom substrate thereof. Namely, DMF device 100 shown in FIG. 8 may include the integrated FETB 150 in bottom substrate 110 along with an integrated matrix driving system. In this example, DMF device 100 takes further advantage of the fact that transistor fabrication is occurring to integrate an active matrix driver in-plane with both the DMF droplet operations electrodes 118 as well as the integrated FETB 150 in bottom substrate 110. This leverages similar fabrication techniques to improve the ability to route multiple droplet operations electrodes 118. DMF device 100 shown in FIG. 8 illustrates an example in which a transistor for active-matrix DMF operations can be integrated in-plane with the FETB system. Further, this integration requires minimal additional circuitry while also drastically increasing the ability to access multiple droplet operations electrodes 118.

In this example, rather than a certain droplet operations electrode 118 being controlled in routing layer 116 (with one unique line per-electrode), routing layer 116 instead routes to a drive source 190 and a drive gate 192. The toggling of both drive source 190 and drive gate 192 enables the droplet operations electrode 118 to receive voltage (i.e., a drive drain 194) and the EWOD effect. Together, drive source 190, drive gate 192, and drive drain 194 form a drive transistor 196. When making this DMF device 100, the drive source layer can be made at the same time as the droplet operations electrodes 118 and the electrodes of FETB 150. The only added fabrication requirement is the addition of a semi-conductor layer for the drive transistor 196, a buried dielectric for the drive gate 192, and a connection to the drive gate 192.

In the examples of the DMF device 100 shown and described hereinabove with reference to FIG. 1 through FIG. 7, the following electrode routing is required:

1× line per droplet operations electrode 118 for control

A shared source line for the sensors (e.g., FETBs 150)

1× line per sensor (e.g., per FETB 150)

Considering that there will be many more droplet operations electrodes 118 vs FETBs 150 (approximately 10× to 100×), this leads to a difficult to route and control system where the number of access pads can become prohibitive. Per the configuration of DMF device 100 shown in FIG. 8, this problem can be mitigated by combining droplet operations electrodes 118 to actuate simultaneously (i.e., short the pads together). However, even still the issue remains. In the configuration of DMF device 100 shown in FIG. 8 the following routing is required.

1 routing line per row of droplet operations electrodes 118

1 routing line per column of droplet operations electrodes 118

A shared source line for the sensors (e.g., FETBs 150)

1× line per sensor (e.g., per FETB 150)

For example, for the DMF device 100 shown in FIG. 1 through FIG. 7, a 64-channel device that may include four FETBs 150 requires 69 control lines. By contrast, the configuration of DMF device 100 shown in FIG. 8 requires only 21 control lines.

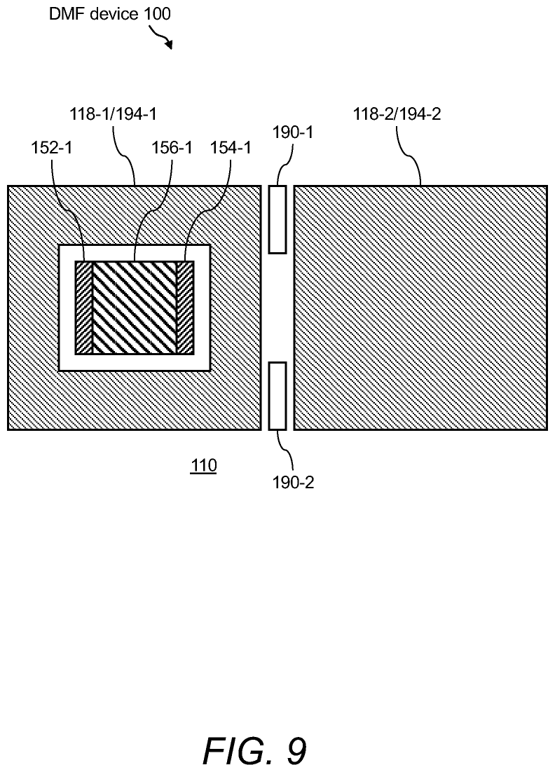

FIG. 9 illustrates a plan view of an example of the patterning of the active-matrix controlled DMF device 100 and FETB 150 shown in FIG. 8. The layout is similar to FIG. 4A and FIG. 4B with the addition of a drive source pad 190 in the area between droplet operations electrodes 118. Not shown is the hydrophobic layer 122 which is also similar to FIG. 4A and FIG. 4B. Note that not every pad will have an integrated (or embedded) FETB 150. Namely, in this example, drive source 190 can be a very small feature that lies within the interstitial area between droplet operations electrodes 118. The primary issue here is that if the drive source row is activated this creates a small hydrophilic area that will attract droplets. Provided that the area is small (e.g., on the order of about 100-200 μm) this region will not substantially perturb droplet operations.

Note that in comparison to FETB 150 shown in FIG. 3, the FETB section remains the same. Similarly, one would expect a reference and FETB return electrode integration either in the top substrate 112 or within the bottom substrate 110.

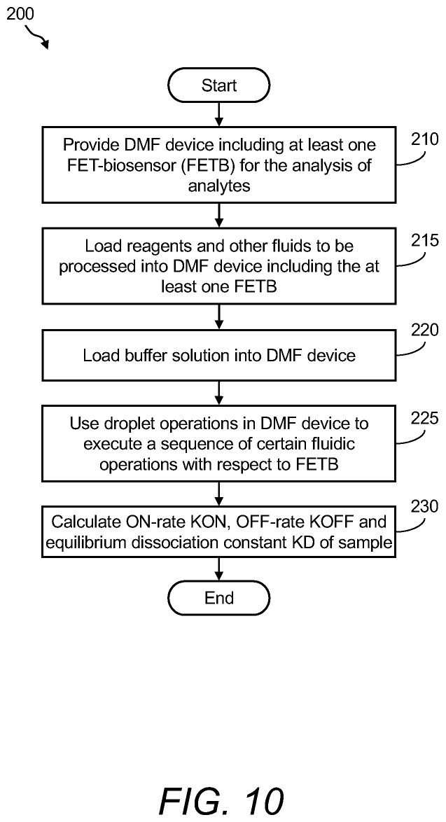

FIG. 10 illustrates a flow diagram of an example of a method 200 of using the presently disclosed subject matter. The following workflow is broadly applicable to all of the examples of DMF device 100 shown hereinabove with reference to FIG. 1 through FIG. 9. This example workflow is to utilize a carboxyl-functionalized FETB device 150 (for example, a graphene gate that has a carboxyl functional group attached to it). FETB device 150 can be used to measure the binding kinetics of a plurality of small-molecule targets to a ligand. Accordingly, method 200 may include, but is not limited to, the following steps.

At a step 210, a DMF device 100 is provided that may include at least one FETB 150 for the analysis of analytes. For example, any one of the DMF devices 100 shown in FIG. 1 through FIG. 9 is provided that may include at least one FETB 150 for the analysis of analytes.

At a step 215, the reagents and other fluids to be processed are loaded into DMF device 100 including the at least one FETB 150. For example, small volumes (1-10 μL typical) of reagent are pipetted into the reagent wells of DMF device 100, including 1-Ethyl-3-(3-dimethylaminopropyl)carbodiimide (EDC), N-Hydroxysuccinimide (NHS), a ligand, and a plurality of samples to test.

At a step 220, buffer solution is loaded into DMF device 100 including the at least one FETB 150. For example, buffer solution is pipetted into the buffer reagent well (10-40 μL typical) of DMF device 100.

At a step 225, droplet operations are used in DMF device 100 to execute a sequence of certain fluidic operations with respect to the at least one FETB 150. The fluidic operations include, for example, the following steps:
(1) using droplet operations, transport a droplet of buffer to FETB 150 to attain a baseline signal;
(2) using droplet operations, mix 1 droplet of EDC with 1 droplet of NHS and replace the droplet of buffer with the mixture. This will activate the carboxyl surface (i.e., gate layer 156 of FETB 150) for ligand immobilization;
(3) using droplet operations, replace the EDC and NHS mixture with buffer to retain baseline;
(4) using droplet operations, replace the buffer with ligand. The ligand will bind to the surface (i.e., gate layer 156 of FETB 150) resulting in a strong change to the FETB current indicating that binding is occurring;
(5) using droplet operations, wash off excess ligand with buffer in order to rinse off any un-bound ligand from gate layer 156 of FETB 150;
(6) optionally, using droplet operations, block the unreacted sites using a blocking agent, such as ethanolamine, to reduce non-specific binding;
(7) using droplet operations, introduce a sample to gate layer 156 of FETB 150. This sample will bind to the ligand which will be visualized by a change in FETB current;
(8) after some association time, use droplet operations to replace the analyte with running buffer. This will cause the analyte to dissociate which will also be visualized as a change in FETB current; and
(9) steps 7 and 8 should be repeated for each analyte. Furthermore, using droplet operations, mix the analytes with running buffer and split the result, thus serially diluting the sample. Typically, 3-5 concentrations per analyte should be tested.

At a step 230, upon the completion of method step 225, the experiment is completed, the ON-rate K_{ON}, OFF-rate K_{OFF} and equilibrium dissociation constant K_{D} can be calculated from the above data. Namely, the DMF device 100 is provided that may include at least one FETB 150 and method 200 can be used to determine the K_{D} value, the K_{ON} value, and/or the K_{OFF} value of the analyte sample with an immobilized ligand, wherein the K_{D} value is a quantitative measurement of analyte affinity, the K_{ON} value indicates the kinetic ON-rate of the analyte sample, and the K_{OFF} value indicates the kinetic OFF-rate of the analyte sample.

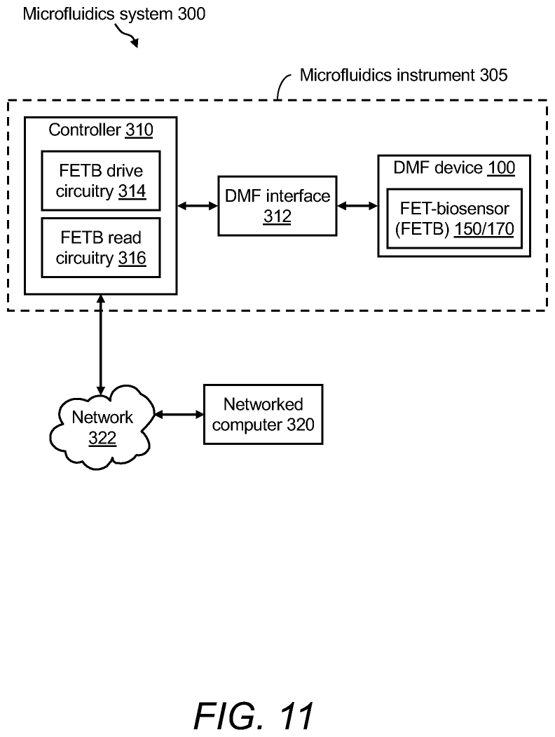

FIG. 11 illustrates a block diagram of an example of a microfluidics system 300 that supports the DMF device 100 that may include an integrated FETB 150 and/or drop-in FETB 170 for the analysis of analytes. Further, microfluidics system 300 can be used to perform method 200 of FIG. 10.

In microfluidics system 300 for analysis of analytes, analysis can mean, for example, detection, identification, quantification, or measuring analytes and/or the interactions of analytes with other substances, such as binding kinetics. Exemplary analytes may include, but are not limited to, small molecules, proteins, peptides, atoms, ions, and the like. For example, microfluidics system 300 can be used to measure the binding kinetics of a ligand to a macromolecule, such as a receptor.

Microfluidics system 300 may include at least one DMF device 100. DMF device 100 provides DMF capabilities generally for merging, splitting, dispensing, diluting, and the like. One application of these DMF capabilities is sample preparation. However, the DMF capabilities may be used for other processes, such as waste removal or flushing between runs.

DMF device 100 may include at least one integrated FETB 150 and/or drop-in FETB 170 that is used for (1) detecting, for example, certain molecules (e.g., target analytes) and/or chemicals in the sample, and (2) for analysis of analytes; namely, for measuring binding events in real time to extract ON-rate information, OFF-rate information, and/or affinity information. DMF device 100 of microfluidics system 300 can be provided, for example, as a disposable and/or reusable cartridge.

Microfluidics system 300 may further include a controller 310 and a DMF interface 312. Controller 310 is electrically coupled to DMF device 100 via DMF interface 312, wherein DMF interface 312 can be, for example, a pluggable interface for connecting mechanically and electrically to DMF device 100. Together, DMF device 100, controller 310, and DMF interface 312 form a microfluidics instrument 305.

Generally, microfluidics system 300 may further include any components and/or functions needed to support DMF device 100 with the least one integrated FETB 150 and/or drop-in FETB 170. For example, using microfluidics system 300, the electrowetting voltage used to induce the movement of droplets in DMF device 100 can be, for example, a DC voltage or an AC voltage. Additionally, in DMF device 100, magnetic or optical forces can be used to localize and/or move fluidic droplets. Further, in DMF device 100, an optical signal can be focused on a semiconductor to generate the electrowetting voltage.

Controller 310 may, for example, be a general-purpose computer, special purpose computer, personal computer, microprocessor, or other programmable data processing apparatus. Controller 310 serves to provide processing capabilities, such as storing, interpreting, and/or executing software instructions, as well as controlling the overall operations of microfluidics system 300. Controller 310 may be configured and programmed to control data and/or power aspects of these devices. For example, with respect to DMF device 100, controller 310 controls droplet manipulation by activating/deactivating electrodes. Generally, controller 310 can be used for any functions of microfluidics system 300. For example, controller 310 can be used to authenticate the DMF device 100 in a fashion similar to how printer manufacturers check for their branded ink cartridges, controller 310 can be used to verify that DMF device 100 is not expired, controller 310 can be used to confirm the cleanliness of DMF device 100 by running a certain protocol for that purpose, and so on.

Additionally, controller 310 may include certain FETB drive circuitry 314 and certain FETB read circuitry 316. FETB drive circuitry 314 can be any drive circuitry for driving the source, drain, and gate of any one or more of the integrated FETBs 150 and/or drop-in FETBs 170 in DMF device 100. FETB read circuitry 316 can be any circuitry for measuring the source-drain current at a given voltage of any one or more of the integrated FETBs 150 and/or drop-in FETBs 170 in DMF device 100.

Additionally, in some embodiments, microfluidics instrument 305 may include capacitive feedback sensing. Namely, a signal coming from a capacitive sensor that can detect droplet position and volume within DMF device 100. Further, in other embodiments, instead of capacitive feedback sensing, microfluidics instrument 305 may include a camera (not shown) to provide optical measurement of the droplet position and volume within DMF device 100, which can trigger controller 310 to re-route the droplets at appropriate positions.

Optionally, microfluidics instrument 305 can be connected to a network. For example, controller 310 can be in communication with a networked computer 320 via a network 322. Networked computer 320 can be, for example, any centralized server or cloud server. Network 322 can be, for example, a local area network (LAN) or wide area network (WAN) for connecting to the internet.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “includes,” and “including” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

The presently disclosed subject matter may be embodied in many different forms and should not be construed as limited to the embodiments set forth herein. Modifications and other embodiments of the presently disclosed subject matter set forth herein will be apparent to one skilled in the art to which the presently disclosed subject matter pertains having the benefit of the teachings presented in the foregoing descriptions and the associated Drawings. The presently disclosed subject matter is not to be limited to the specific embodiments disclosed and that modifications and other embodiments are intended to be included within the scope of the appended claims.

1. A digital microfluidics (DMF) device comprising:
one or more electrodes for conducting droplet operations; and
a field effect transistor biosensor (FETB), wherein the FETB is disposed relative to the one or more electrodes to contact a droplet that is positionable by the one or more electrodes relative to at least a first portion of the FETB; and
wherein the first portion of the FETB comprises a hydrophilic surface area of the FETB that is sized relative to the droplet such that the one or more electrodes is capable of conducting a droplet operation to remove the droplet from contact with the hydrophilic surface area of the FETB.

2. The DMF device of claim 1, further comprising:
a hydrophobic layer extending relative to at least a second portion of the FETB, wherein the hydrophobic layer is disposed between the second portion of the FETB and the droplet when the droplet is in contact with the first portion of the FETB, and wherein the hydrophobic layer does not extend relative to the first portion of the FETB.

3. The DMF device of claim 2, wherein the second portion of the FETB comprises a source of the FETB and a drain of the FETB.

4. The DMF device of claim 1, wherein the first portion of the FETB comprises a gate layer of the FETB and a return electrode.

5. The DMF device of claim 4, wherein the gate layer comprises a graphene gate comprising carboxyl functional groups that server as analyte capture elements to modulate a gate voltage of the FETB when contacted by the droplet comprising an analyte.

6. The DMF claim 1, wherein the first portion of the FETB comprises a ground reference electrode.

7. The DMF device of claim 1, wherein the first portion of the FETB comprises a hydrophilic area comprising not more than about 10% of a droplet footprint area of the droplet relative to the FETB.

8. The DMF device of claim 1, wherein the first portion of the FETB comprises a hydrophilic area of not less than about 0.01 mm² and not greater than about 0.1 mm².

9. The DMF device of claim 1, wherein removal of the droplet comprises removal of at least about 95 volume percentage of the droplet from the first portion of the FETB.

10. The DMF device of claim 1, further comprising:
a first substrate comprising the one or more electrodes for conducting droplet and a first hydrophobic layer, wherein the first hydrophobic layer comprises a first droplet operations surface opposite the one or more electrodes;
a second substrate disposed relative to the first substrate and comprising at least one ground reference electrode and a second hydrophobic layer, wherein the second hydrophobic layer comprises a second droplet operations surface opposite the ground reference electrode; and
a droplet operation gap defined between the first droplet operation surface of the first substrate and the second droplet operations surface of the second substrate.

11. The DMF device of claim 10, wherein at least one of the first hydrophobic layer or the second hydrophobic layer comprises an opening through which the first portion of the FETB is contactable by the droplet when positionable by the one or more electrodes relative to the first portion of the FETB.

12. The DMF device of claim 10, wherein the first substrate comprises the FETB, wherein the second substrate comprises the FETB, or wherein the first substrate comprises a first FETB, and the second substrate comprises a second FETB.

13. (canceled)

14. (canceled)

15. The DMF device of claim 14, wherein one of the first FETB or the second FETB comprises a measurement sensor and the other of the first FETB or the second FETB comprises a reference sensor.

16. The DMF device of claim 10, wherein the first substrate comprises a routing layer in electrical communication with the one or more electrodes.

17. The DMF device of claim 16, wherein the routing layer comprises an active matrix driver to selectively activate ones of the one or more electrodes.

18. The DMF device of claim 17, wherein the active matrix driver comprises a drive transistor comprising a drive source and a drive gate.

19. The DMF device of claim 10, further comprising:
a drop-in portion separate from the first substrate or the second substrate and comprising the FETB, wherein the drop-in portion is selectably engageable to dispose the FETB relative to the droplet operations gap to dispose the first portion in contactable relation with a droplet in the droplet operations gap.

20. The DMF device of claim 19, wherein at least one of the first substrate or the second substrate comprises an aperture for receiving the drop-in portion.

21. A digital microfluidics (DMF) system, comprising:
an instrument comprising:
FETB drive circuitry,
FETB read circuitry, and
droplet operations electrode controller circuitry; and
a DMF device according to claim 1 comprising a cartridge, wherein the instrument comprises a mount for physically engaging the cartridge with the instrument, and wherein the mount comprises one or more connectors for establishing electrical communication between the cartridge and the instrument.

22. A method of detecting an analyte in a sample fluid using a digital microfluidics (DMF) device, comprising:
moving a sample droplet of the sample fluid into contacting engagement with a first portion of a field effect transistor biosensor (FETB) by operation of one or more electrodes, wherein the first portion of the FETB comprises a hydrophilic surface area of the FETB;
detecting an analyte in the sample droplet using the FETB; and
manipulating the sample droplet away from the FETB to remove the sample droplet from the contacting engagement with the hydrophilic surface area of the FETB.

23.-28. (canceled)
